(19) United States
(12) Patent Application Publication
(10) Pub. No.: US 2010/0236871 A1
(43) Pub. Date: Sep. 23, 2010

(54) ELEVATOR DOOR VIBRATION AND NOISE ISOLATOR

(75) Inventors: Jie Xiao, Rochester Hills, MI (US); John Ferrisi, Southington, CT (US); Patricia L. Driesch, Manchester, CT (US); Charles C Coffin, Vernon, CT (US); John P. Wesson, Vernon, CT (US)

Correspondence Address: KINNEY AND LANGE PA, 312 S THIRD STREET, MINNEAPOLIS, MN, 55415, US

(73) Assignee: OTIS ELEVATOR COMPANY, Farmington, CT (US)

(21) Appl. No.: 12/681,345

(22) PCT Filed: Nov. 1, 2007
(86) PCT No.: PCT/US07/23092

§ 371 Date: Apr. 1, 2010

(51) Int. Cl. B66B 13/30; F16M 13/02; E05D 15/06

(52) U.S. Cl. 187/334; 16/87 R

(57) ABSTRACT

An elevator door hanger apparatus includes a door hanger configured to be attached to a top portion of a door panel and to at least one movable member and an isolator plate attached to the door hanger and including a lip extending from a bottom of the isolator plate away from the door hanger.

### BACKGROUND

The present invention relates to vibration and noise damping and isolation. In particular, the present invention relates to damping and isolating vibration and noise transmitted to elevator car doors.

A common challenge in elevator system design is damping and isolating vibration and noise to improve the ride quality in the elevator car. A significant source of vibration and noise that reaches the elevator car emanates from the elevator car doors. Elevator car doors commonly include two panels, which meet at the center of the doorway when closed and move outward toward the elevator car sides to open. The door panels hang from a header arranged above the doorway and extending from one side to the other side of the car. The hangers attached to the door panels are connected to movable members, for example rollers, which engage a track on the header. Elevator car door vibration and noise commonly emanates from the roller and track and then propagates through the hanger to the door panels. Prior elevator systems have failed to adequately dampen and isolate car door vibration.

### SUMMARY

The present invention includes an elevator door hanger apparatus comprising a door hanger configured to be attached to a top portion of a door panel and to at least one movable member and an isolator plate attached to the door hanger and including a lip extending from a bottom of the isolator plate away from the door hanger.

Embodiments of the present invention also include an elevator door apparatus comprising at least one door panel, at least one door hanger attached to a top portion of the at least one door panel, and at least one isolator plate attached to the at least one door hanger and including a lip extending from a bottom of the at least one isolator plate away from the at least one door hanger.

### BRIEF DESCRIPTION OF THE DRAWINGS

FIG. 1 is a perspective view of an elevator system according to the present invention.

FIG. 2 is a detail view of the elevator system of FIG. 1.

FIG. 3 is a detail side view of the elevator system of FIGS. 1 and 2 showing the interconnection between the elevator car and the door panels.

FIGS. 4A-4C are partial side views showing different embodiments of an isolator plate adapted to improve damping and isolation performance.

### DETAILED DESCRIPTION

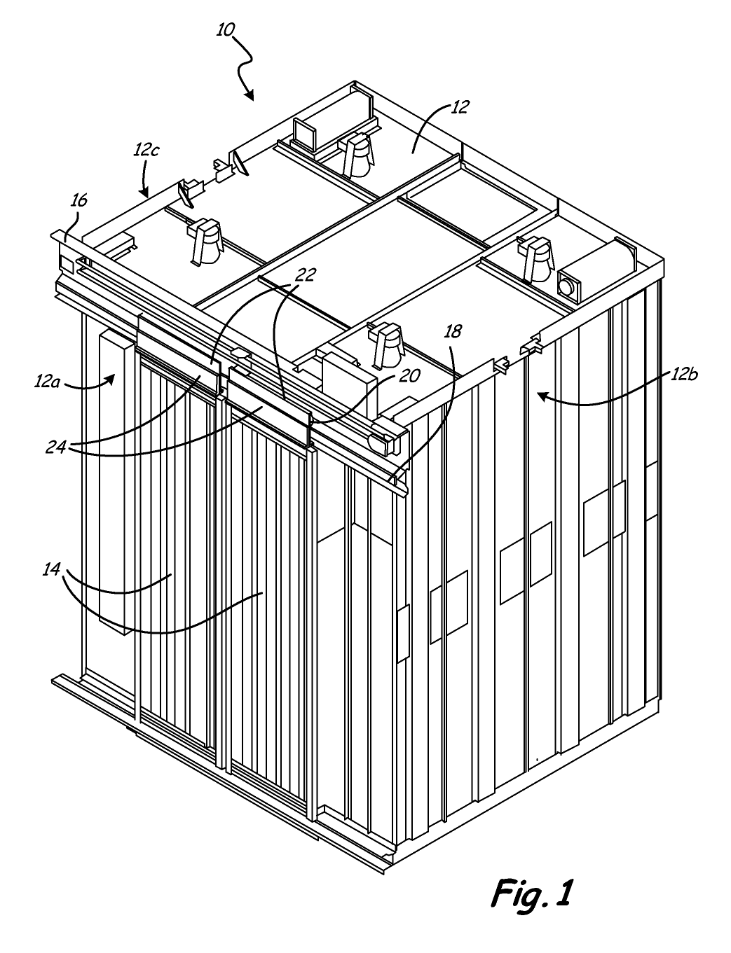

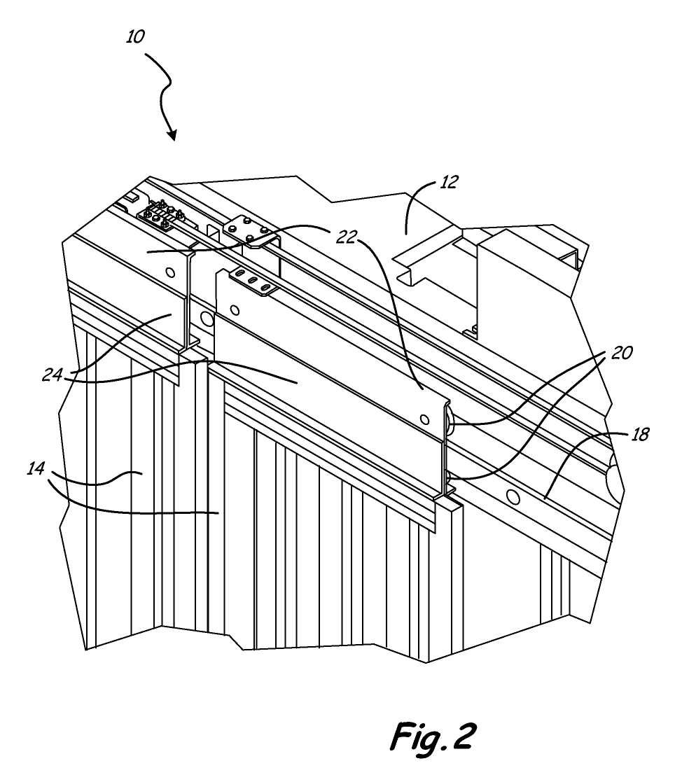

FIG. 1 is a perspective view of elevator system 10 according to the present invention and FIG. 2 is a detail view of elevator system 10, which system includes car 12, door panels 14, header 16, track 18, rollers 20, hangers 22, and isolator plates 24. In FIGS. 1 and 2, door panels 14 are arranged on first side 12a of car 12 and are configured to open and close toward second and third sides 12b, 12c of car 12. Header 16 is arranged above door panels 14 and extends toward second and third sides 12b, 12c of car 12. Header 16 includes a track 18 arranged along the length of header 16 from second side 12b to third side 12c of car 12. Track 18 is configured to receive movable members, such as rollers 20 arranged above and below track 18 as shown in FIG. 2. Rollers 20 engage track 18 to move along track 18 toward second and third sides 12b, 12c of car 12. Hangers 22 are connected to rollers 20 and extend down from header 16 to connect to door panels 14. Isolator plates 24 are connected to hangers 22 above door panels 14. As shown in FIG. 2, each of isolator plates 24 may be a generally elongated L-shaped plate having a short leg, or “lip,” along the bottom of isolator plate 24 and extending away from hanger 22 and door panel 14.

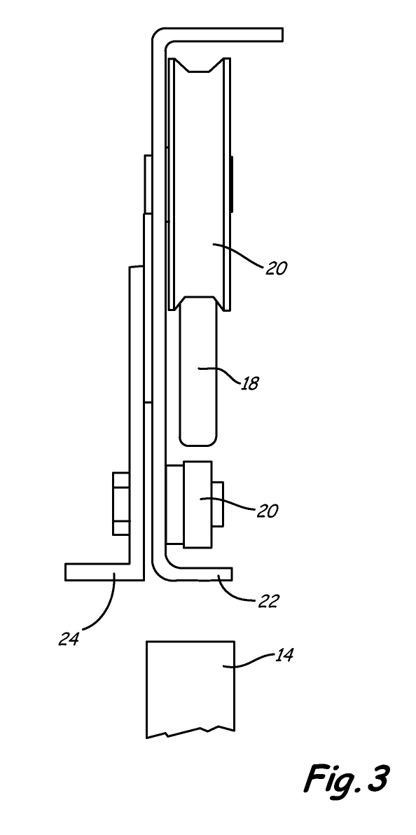

FIG. 3 is a detail side view of elevator system 10 showing the interconnection between elevator car 12 and door panels 14, which interconnection includes door panel 14, track 18, rollers 20, hanger 22, and isolator plate 24. In FIG. 3, door panel 14 is exploded from hanger 22. Elongated L-shaped isolator plate 26 has a long leg attached to hanger 22 and a lip extending along the bottom of isolator plate 24 away from hanger 22 and door panel 14. Door panel 14 is configured to move from side-to-side (perpendicular to the view shown in FIG. 3) as rollers 20, connected to hangers 22, move along track 18. Elevator system 10 commonly produces or encounters mechanical vibrations and noise during operation. One source of vibration and noise in elevator system 10 emanates from the connection between door panels 14 and car 12 at header 16, for example emanating from the motion of rollers 20 along track 18. Vibration and noise in elevator system 10 that reaches door panels 14 substantially degrades the ride quality for passengers riding in car 12. Isolator plates 24 are configured to dampen and isolate vibration and noise transmitted from hangers 22 to door panels 14. For example, vibration and noise may be generated from the motion of rollers 20 along track 18. The vibration and noise is transmitted from rollers 20 to hanger 22. Instead of transmitting the vibration and noise directly to door panel 14, a portion of the energy is diverted to isolator plate 24 connected to hanger 22. Additionally, the lip of isolator plate 24 acts to direct vibration and noise absorbed by isolator plate 24 away from door panel 14. Isolator plate 24 therefore may decrease the amplitude of vibration and noise that reaches door panel 14 by absorbing and diverting a portion of the energy transmitted from hanger 22.

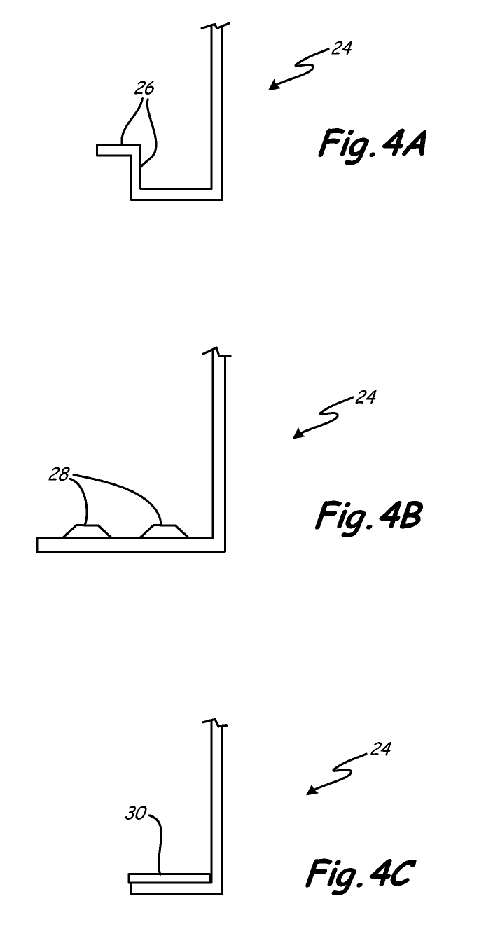

Isolator plate 24 may be adapted, for example by lengthening the lip, to increase vibration and noise damping and isolation. FIGS. 4A-4C show alternative embodiments of the present invention in which isolator plate 24 is adapted to improve performance. The shape of the lip of isolator plate 24 may be changed, for example by adding one or more bends 26 as the lip extends away from door hanger 22 as shown in FIG. 4A. The one or more bends 26 added to the lip of isolator plate 24 act to stiffen the junction between door panel 14 and door hanger 22, which in turn may act to increase vibration and noise damping and isolation. Bends 26 added to the lip of isolator plate 24 may also be configured to tune the performance of isolator plate 24 to different frequency bands encountered in different elevator systems and operating conditions. Additionally, surface variations 28, such as dimples, may be added to the lip of isolator plate 24 as shown in FIG. 4B. Adding surface variations 28, such as dimples, to the lip of isolator plate 24 acts to decrease the amount of noise radiated from isolator plate 24 by increasing the surface area across which noise transmissions may be dissipated. In some embodiments according to the present invention, one or more surfaces of isolator plate 24 may be coated with damping material 30 as shown in FIG. 4C. Damping materials used in such embodiments to coat one or more surfaces of isolator plate 24 include viscous and viscoelastic materials. Coating isolator plate 24 with damping material 30 acts to increase vibration and noise isolation by adding another material into which energy may be transmitted and isolated.

Isolator plate 24 may be made from well known materials, such as various steels selected based on the intended application. Isolator plate 24 may be made by conventional manufacturing techniques, such as cutting and bending sheet metal to the appropriate size and shape.

Embodiments of the present invention provide significant advantages over prior elevator door assemblies and elevator cars including such assemblies. A significant source of vibration and noise that reaches the elevator car in prior elevator systems emanates from the elevator car doors. Elevator car door vibration and noise commonly emanates from the roller and track and then propagates through the hanger to the door panels. Embodiments of the present invention include an isolator plate attached to the door hanger and configured to dampen and isolate vibration and noise transmitted from the door hanger to the elevator car door panels. The isolator plate acts to divert a portion of the vibration and noise energy transmitted from the door hanger to the door panel and thereby decreases the amplitude of vibration and noise that reaches the door panel by absorbing a portion of the energy transmitted from the hanger.

Although the present invention has been described with reference to preferred embodiments, workers skilled in the art will recognize that changes may be made in form and detail without departing from the spirit and scope of the invention.

1. An elevator door hanger apparatus comprising:
a door hanger configured to be attached to a top portion of a door panel and to at least one movable member; and
an isolator plate attached to the door hanger and including a lip extending from a bottom of the isolator plate away from the door hanger.

2. The apparatus of claim 1, wherein the lip of the isolator plate is substantially straight along the direction the lip extends away from the door hanger.

3. The apparatus of claim 1, wherein the lip of the isolator plate comprises one or more bends as the lip extends away from the door hanger.

4. The apparatus of claim 1, wherein the lip of the isolator plate is substantially perpendicular to the door hanger.

5. The apparatus of claim 1, wherein the lip of the isolator plate comprises one or more surface variations.

6. The apparatus of claim 5, wherein the one or more surface variations comprise one or more dimples.

7. The apparatus of claim 1, wherein the isolator plate comprises steel.

8. The apparatus of claim 1, wherein the isolator plate further comprises a damping material on one or more surfaces of the isolator plate.

10. The apparatus of claim 8, wherein the damping material is selected from a group of damping materials comprising viscous and viscoelastic materials.

11. The apparatus of claim 1, wherein the isolator plate is configured to dampen and isolate vibration and noise encountered by the hanger apparatus.

12. An elevator door apparatus comprising:
at least one door panel;
at least one door hanger attached to a top portion of the at least one door panel; and
at least one isolator plate attached to the at least one door hanger and including a lip extending from a bottom of the at least one isolator plate away from the at least one door hanger.

13. The apparatus of claim 12, wherein the lip of the at least one isolator plate is substantially straight along the direction the lip extends away from the at least one door hanger.

14. The apparatus of claim 12, wherein the lip of the at least one isolator plate comprises one or more bends as the lip extends away from the at least one door hanger.

15. The apparatus of claim 12, wherein the lip of the at least one isolator plate is substantially perpendicular to the at least one door hanger.

16. The apparatus of claim 12, wherein the lip of the at least one isolator plate comprises one or more surface variations.

17. The apparatus of claim 16, wherein the one or more surface variations comprise one or more dimples.

18. The apparatus of claim 12, wherein the at least one isolator plate comprises steel.

19. The apparatus of claim 12, wherein the at least one isolator plate further comprises a damping material on one or more surfaces of the at least one isolator plate.

20. The apparatus of claim 19, wherein the damping material is selected from a group of damping materials comprising viscous and viscoelastic materials.

21. The apparatus of claim 12, wherein the at least one isolator plate is configured to dampen and isolate vibration and noise encountered by the elevator door apparatus.

22. An elevator car comprising:
at least one door panel configured to move in a doorway of the elevator car;
a header connected to the elevator car above the doorway and including at least one track;
at least one door hanger attached to a top portion of the at least one door panel;
at least one movable member attached to the at least one door hanger and engaging the at least one track; and
at least one isolator plate attached to the at least one door hanger and including a lip extending from a bottom of the at least one isolator plate away from the at least one door hanger.

23. The elevator car of claim 22, wherein the lip of the at least one isolator plate is substantially straight along the direction the lip extends away from the at least one door hanger.

24. The elevator car of claim 22, wherein the lip of the at least one isolator plate comprises one or more bends as the lip extends away from the at least one door hanger.

25. The elevator car of claim 22, wherein the lip of the at least one isolator plate is substantially perpendicular to the at least one door hanger.

26. The elevator car of claim 22, wherein the lip of the at least one isolator plate comprises one or more surface variations.

27. The elevator car of claim 26, wherein the one or more surface variations comprise one or more dimples.

28. The elevator car of claim 22, wherein the at least one isolator plate comprises steel.

29. The elevator car of claim 22, wherein the at least one isolator plate further comprises a damping material on one or more surfaces of the at least one isolator plate.

30. The elevator car of claim 29, wherein the damping material is selected from a group of damping materials comprising viscous and viscoelastic materials.

31. The elevator car of claim 22, wherein the at least one isolator plate is configured to dampen and isolate vibration and noise encountered by the elevator car.

32. The elevator car of claim 22, wherein the at least one movable member comprises at least one rolling member.

33. The elevator car of claim 22, wherein the at least one movable member comprises at least one sliding member.
